(19) United States
(12) Patent Application Publication
(10) Pub. No.: US 2026/0226923 A1
(43) Pub. Date: Aug. 6, 2026

(54) Motion Driven Filtration System

(71) Applicant: THE OILGEAR COMPANY, Traverse City, MI (US)

(72) Inventors: Mitch Terhune, Williamsburg, MI (US); SAMUEL HOLMES, Williamsburg, MI (US); Alex Gertz, Traverse City, MI (US)

(21) Appl. No.: 19/529,597

(22) Filed: Feb. 4, 2026

Related U.S. Application Data
(60) Provisional application No. 63/917,643, filed on Nov. 14, 2025.
(60) Provisional application No. 63/753,761, filed on Feb. 4, 2025.

(51) Int. Cl. F15B 21/041; F15B 13/02

(52) U.S. Cl. CPC F15B 21/041; F15B 13/021; F15B 13/027

(57) ABSTRACT

A system for filtering hydraulic fluid that is periodically pressurized by a compensation cylinder attached to an external load. A first filter, a first flow control valve that passes fluid from the compensation cylinder under a first higher pressure to the first filter, and a second flow control valve that passes fluid back to the compensation cylinder when the compensation cylinder produces a second lower pressure.

### CROSS-REFERENCE TO RELATED CASES

This application claims the benefit of U.S. provisional patent application Serial No. 63/753,761, filed on 2/4/2025, and U.S. provisional patent application Serial No. 63/917,643, filed on November 14, 2025 and incorporates both provisional applications by reference into this disclosure as if fully set out at this point.

### FIELD OF THE INVENTION

This disclosure relates to hydraulic fluid filtration in general and, more particularly, to hydraulic fluid filtration in closed systems under pressure, such as a motion compensation system.

### BACKGROUND OF THE INVENTION

Filtration in hydraulic systems is critical to long term performance and overall system life. Most systems have external low pressure tanks that make circulating and filtering fluid a simple task. However, some systems such as offshore motion compensation systems are closed systems with a calibrated volume of fluid under pressure. These systems wear and become dirty and require filtration.

Current filtration solutions require the addition of electronics, pumps, fluid sensing hardware, and draining fluid from the system. These systems are costly and marginally effective.

What is needed is a system for addressing the above and related issues.

### SUMMARY OF THE INVENTION

The invention of the present disclosure, in one aspect thereof, comprises a system for filtering hydraulic fluid operating in a motion compensation system. The filtering system includes an inlet filter hydraulically connected to the motion compensation system via a first flow control valve to receive a portion of fluid passed under pressure from the motion compensation system to the accumulator, and an outlet filter hydraulically connected to the motion compensation system via a second flow control valve. The outlet filter is hydraulically connected to the inlet filter to return at least a portion of the fluid received at the inlet filter back to the motion compensation system when the motion compensation system reduces an internal pressure.

The first and second flow control valves may comprise first and second check valves, respectively. The system may include a filter accumulator hydraulically connected to the inlet filter and outlet filter.

The system may have a first isolation valve interposing the inlet filter and the motion compensation system. The system may have a second isolation valve interposing the outlet filter and the motion compensation system. In some embodiments, the first flow control valve interposes the first isolation valve and the inlet filter. The second flow control valve may interpose the second isolation valve and the outlet filter.

Some embodiments of the system comprise a manifold containing the first and second flow control valves and the first and second isolation valves. The manifold may be affixed to a first external canister containing the inlet filter, and a second external canister containing the outlet filter. The manifold may provide an external connection to the inlet filter via the first isolation valve and the first flow control valve, and a second external connection to the outlet filter via the second isolation valve second flow control valve.

The invention of the present disclosure, in another aspect thereof, comprise a system for filtering hydraulic fluid that is periodically pressurized by a motion compensation system attached to an external load. Such filtering system comprises a first filter, a first flow control valve that passes fluid from the motion compensation system under a first higher pressure to the first filter, and a second flow control valve that passes fluid back to the motion compensation system when the motion compensation system produces a second lower pressure.

The system may further include a second filter that filters fluid as it is passed back to the motion compensation system. The system may have a first isolation valve that selectively stops the flow of hydraulic fluid from entering the first filter. The system may have a second isolation valve that selectively stops the flow of fluid from leaving the second filter from flowing back to the motion compensation system.

Some embodiments have a filter accumulator that receives filtered fluid from the first filter before it is passed back to the motion compensation system. The system may comprise a third isolation valve that selectively interrupts hydraulic fluid flow to and from the filter accumulator.

The system may further comprise a manifold containing the first and second flow control valves and the first, second, and third isolation valves, and providing interconnections between the first and second filters, the filter accumulator, and the motion compensation system.

The invention of the present disclosure, in another aspect thereof, comprises a method for filtering hydraulic fluid circulating from a motion compensation system at periodic first higher pressures and second lower pressures. The method includes receiving the hydraulic fluid from the motion compensation system at the first higher pressure through a first flow control valve and a first filter, and returning the hydraulic fluid to the motion compensation system at the second lower pressure through a second flow control valve.

The method may include passing the hydraulic fluid through a second filter before it enters the second flow control valve. The method may also include receiving hydraulic fluid from the first filter into a filter accumulator before it is passed through the second filter.

### BRIEF DESCRIPTION OF THE DRAWINGS

FIG. 1 is a hydraulic circuit schematic diagram of a hydraulic fluid filtration system according to aspects of the present disclosure.

FIG. 2 is a perspective view of a hydraulic fluid filtration system according to aspects of the present disclosure.

FIG. 3 is an overhead view of a hydraulic fluid filtration system according to aspects of the present disclosure.

FIG. 4 is a rear closeup perspective view of a hydraulic fluid filtration system according to aspects of the present disclosure.

### DETAILED DESCRIPTION OF THE PREFERRED EMBODIMENTS

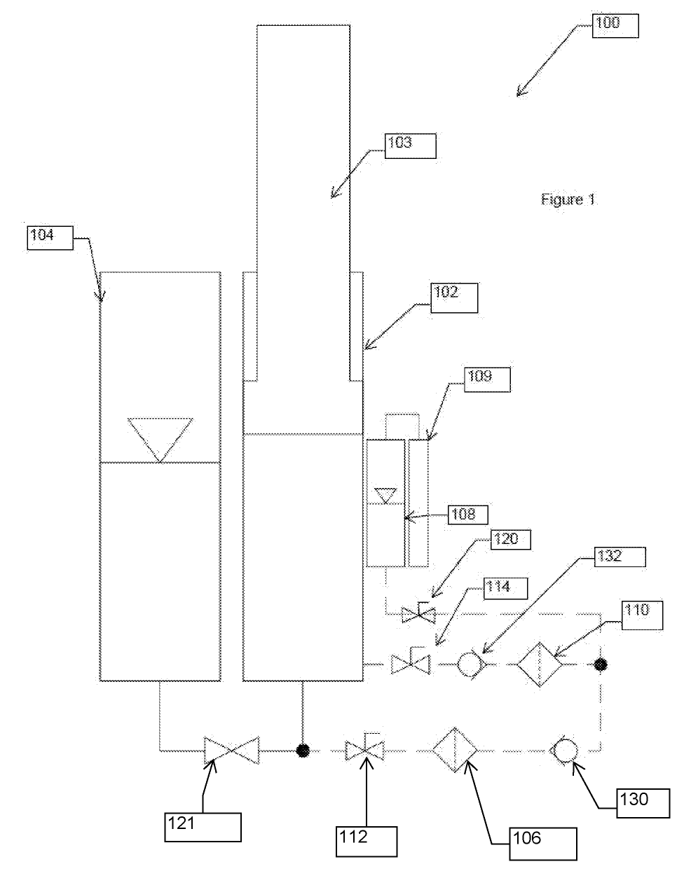

Referring now to FIG. 1, a hydraulic circuit schematic diagram of a hydraulic fluid filtration system 100 according to aspects of the present disclosure is shown. In various embodiments, hydraulic fluid filtration system 100 may filter any passive compensation system, such as on any part of a drilling rig. In various embodiments, hydraulic fluid filtration system 100 may provide continuous filtration while a tensioner is in operation and does not require external power. The hydraulic fluid filtration system 100 may utilize tensioner pressure during a heave cycle to passively drive fluid through filter elements.

It should be understood that FIG. 1 is exemplary only, and that the system 100 may be adaptable to other configurations by one of skill in the art with the benefit of the present disclosure. The hydraulic fluid filtration system 100 may interconnect to a hydraulic cylinder 102 that supports a load on a moving platform (e.g., a drilling rig) as part of a motion compensation system. The motion of the vessel or platform moves a compensating cylinder piston 103 in and out of the cylinder 102 based on the motion of the vessel or platform. A high pressure accumulator 104 (“HPA”) may be interconnected to the hydraulic cylinder 102 via a motion compensation valve 121 (also known as an anti-recoil valve or “ARV”). The cylinder 102, piston 103, accumulator 104, and/or valve 121 may comprise all or a portion of a motion compensation system (absent the other components shown and/or described) as may be known to those of skill in the art. In some embodiments, the hydraulic fluid filtration system 100 and others of the present disclosure described herein may be considered to also comprise the cylinder 102, piston 103, accumulator 104, and or valve 121. In other embodiments, the filtration system 100 is considered a separate device to be added to a compensation system as shown or otherwise known to the art. Additionally, some motion compensation systems utilize multiple hydraulic cylinders and may utilize cables, pulleys, and other mechanisms known to the art. Systems of the present disclosure may be used with any hydraulic system providing for movement of fluid in and out of the cylinder. Additional power or pumps are not needed. Moreover, the hydraulic fluid may be filtered at operational pressure.

The hydraulic fluid filtration system 100 may be placed on a skid located on a flat surface near the tensioner, and may be hydraulically connected using existing ports on an anti-recoil valve (ARV) or high pressure accumulator (“HPA”) drain. When the piston 103 moves hydraulic fluid toward an accumulator 104 (e.g., an HPA), it compresses gas in the accumulator and subsequently raises the pressure in the hydraulic system 100. As the motion of a vessel attached to the cylinder 102 or piston 103 reaches its maximum, so does the system pressure in the hydraulic system 100. When the attached vessel moves in the opposite direction, the pressure will fall as the gas volume is allowed to expand when the compensating equipment extends (e.g., the piston 103 extends). This creates a sinusoidal pressure curve in the hydraulic system 100, or an otherwise periodically changing pressure in the hydraulic system 100. By utilizing this change in pressure, the system 100 creates a pumping action that moves fluid across one or more filters, such as inlet filter 106 and outlet filter 110. The cylinder 102 and accumulator 104 may be interconnected via a motion compensation valve 121, (known in some instances as an anti-recoil valve (“ARV”).

When hydraulic pressure in the accumulator 104 and/or cylinder 102 increases, hydraulic fluid may move through inlet filter 106. When pressure in the accumulator 104 and/or cylinder 102 decreases, hydraulic fluid may move through outlet filter 110 and into cylinder 103 and accumulator 104. This sinusoidal increase and decrease of pressure is resultant from movement of the load (e.g., rig or vessel) attached to the cylinder 102 or piston 103.

In some embodiments, a filter accumulator 108 takes up hydraulic fluid under high pressure that has moved through the inlet filter 106 but has not yet returned through the outlet filter 110. Such fluid may be returned to the circuit under pressure from the accumulator 108 when the cylinder 103 extends. Some embodiments may have an additional air or gas bottle 109 coupled to the accumulator 108 providing additional gas capacity.

An inlet flow control valve 130 may ensure that hydraulic fluid flow only one way into the inlet filter 106. An outlet flow control valve 132 may ensure that fluid flows only one way out of the outlet filter 110. In some embodiments, the one way flow of hydraulic fluid through the flow control valves 130, 132 and/or filters 106, 110 may be only substantially one way. In various embodiments, this means that some reverse flow or leakage is present but at a reduced rate compared to the primary one way flow.

It should also be understood that more or fewer filters may be provided in other embodiments. For example, in some embodiments, one or more inlet filters (such as inlet filter 106) may be used, while no outlet filter is utilized. In other embodiments, one or more outlet filters (such as outlet filters 110) may be used, while no inlet filter is used. In some embodiments, filtration may be sufficiently achieved by a single filter. This could be either inlet filter 106, outlet filter 110, or another filter placed elsewhere in the hydraulic circuit.

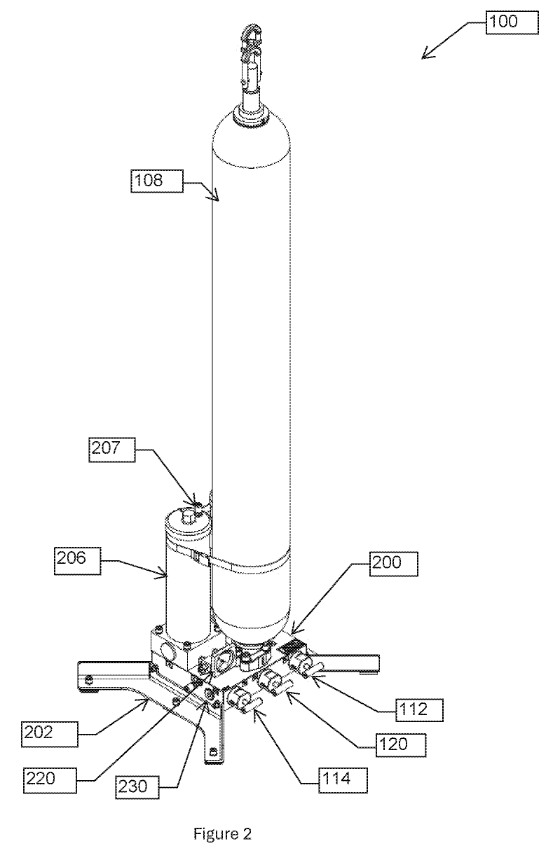

The filtration loop capacity can easily be changed by increasing the filter loop accumulation as well as adding additional air volume. The volume of fluid moving across the filters 106, 110 may be relatively small, but happens often. This results in a large volume of fluid passing across the filters 106, 110 each day. Indicators can be added to the unit to provide filter status and flow information to help with service (e.g., a differential pressure gauge 220 of FIGS. 2-4). Where a single filter is used the change interval may decrease, or a larger filter may be needed to achieve a similar change interval as when using multiple filters.

Isolation valves can be provided to facilitate filter changes without fluid loss or for other servicing procedures. In the illustrated embodiment, an inlet isolation valve 112 allows for isolation or blocking of the inlet filter 106 from the accumulator 104 and external components such as cylinder 102. An outlet isolation valve 114 allows for isolation or blocking of the outlet filter 110 from the accumulator 104 and external components such as cylinder 102. In some embodiments, an accumulator isolation valve 120 closes off the accumulator 108 isolates the accumulator 108 hydraulically from the rest of the device 100.

In various embodiments, the isolation valves 112, 114, 120 may comprises any suitable valves. For example, isolation valves 112, 114, 120 may comprise manually operated valves, pilot operated valves, pressure switch valves, electronically operated valves, or others. Isolation valves 112, 114, 120 are not necessarily the same specific type of valve. Isolation valves 112, 114, 120 may not be included in all embodiments and more or fewer isolation valves may be provided than are shown.

Flow control valves 130, 132 are also optional in some embodiments. Flow control valves 130, 132 may be placed differently than shown. For example, flow control valves 130, 132 may be placed on opposite sides of the respective filters 106, 110 than shown in FIG. 1. Either or both of the flow controls valves 130, 132 may comprise check valves such as ball check valves or other check valve. Flow control valves 130, 132 also be or comprise other suitable valves capable of providing the desired one way flow function (including, for example automated, pilot operated valves, pressure switch valves, electronically operated valves, one-way flow valves, or others). Flow control valves 130, 132 are not necessarily both the same kind specific type of valve.

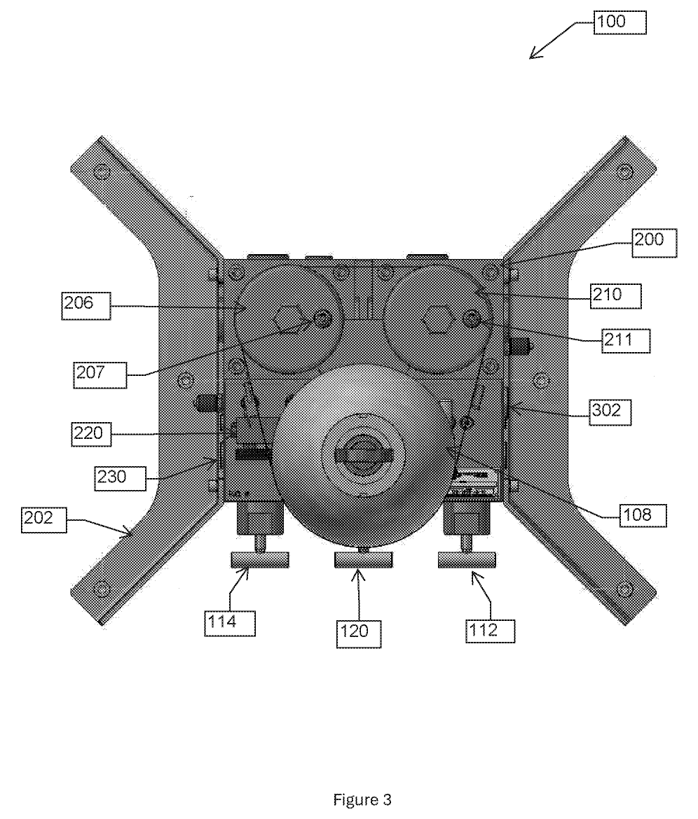

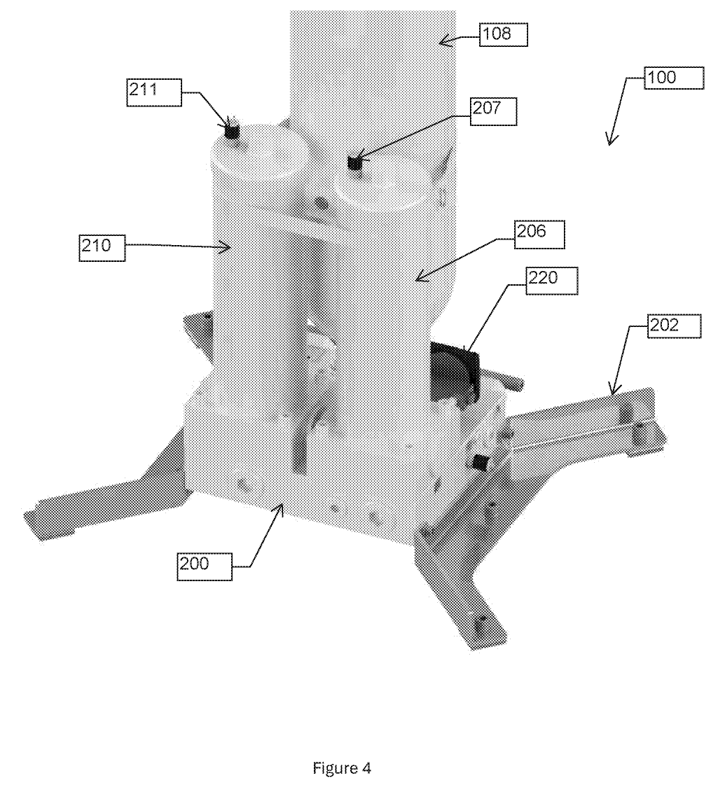

Referring now also to FIG. 2, a perspective view of a hydraulic fluid filtration system 100 according to aspects of the present disclosure is shown. FIG. 3 is an overhead view of the hydraulic fluid filtration system 100, and FIG. 4 is a rear closeup perspective view of the hydraulic fluid filtration system 100. FIGS. 2-4 illustrate possible external and physical appearance of the hydraulic fluid filtration system 100. It should be appreciated, however, that physical appearances may differ from that shown unless otherwise specified in the claims.

The hydraulic fluid filtration system 100 may comprise a valve manifold 200 that contains the aforementioned isolation valves 112, 114, 120, ball valves 130, 132 (internal to the manifold 200) and other portions of the functional hydraulic circuit as described. The manifold 200 may interconnect to the accumulator 104, an inlet filter canister 206 (containing, e.g., inlet filter 106), and an outlet filter canister 210 (containing, e.g., outlet filter 110). The filter canisters 206, 210 may be openable for replacement or servicing of filters 106, 110, respectively. The canisters 206, 210 may also provide bleed valves 207, 211, respectively. Other bleed valves, service ports, connections, and other components as known to the art may be provide on or within the manifold 200 as well.

An inlet connection 230 may be provided on an external surface of the manifold in the position shown or at another convenient location. Similarly, an outlet connection 302 may be provided on an external surface of the manifold 200 as shown or at another convenient location. The may connect to cylinder 102 as shown in FIG. 1, or to another hydraulic component that provides periodic or sinusoidal pressure gradients and is therefore suitable for being filtered by systems and methods of the present disclosure.

The manifold 200 may be mounted onto a skid or base 202, which may, in turn, be mounted elsewhere to secure the system 100 in a convenient location for use or transport.

In operation, the hydraulic fluid filtration system 100 filters active hydraulic fluid under operational pressure in a continuous manner. This may allow the filters 106, 110 to have a more predictable lifespan. The pressure differential gauge 230 may be configured to show the pressure gradient or differential across the outlet filter 110. The high pressure detected by such gauge during each repeating cycle of the piston 103 (for example) may allow determination of when the filter 110 and/or filter 106 are in need or replacement or service. In some embodiments, the filters 106, 110 may be specified or designed to capture different sizes of particles (e.g., the inlet filter 106 capture relatively larger particles or debris while the outlet filter 110 captures finer or smaller particles or debris.

It is to be understood that the terms "including", "comprising", "consisting" and grammatical variants thereof do not preclude the addition of one or more components, features, steps, or integers or groups thereof and that the terms are to be construed as specifying components, features, steps or integers.

If the specification or claims refer to "an additional" element, that does not preclude there being more than one of the additional element.

It is to be understood that where the claims or specification refer to "a" or "an" element, such reference is not be construed that there is only one of that element.

It is to be understood that where the specification states that a component, feature, structure, or characteristic "may", "might", "can" or "could" be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term "method" may refer to manners, means, techniques and procedures for accomplishing a given task including, but not limited to, those manners, means, techniques and procedures either known to, or readily developed from known manners, means, techniques and procedures by practitioners of the art to which the invention belongs.

The term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%.

When, in this document, a range is given as “(a first number) to (a second number)” or “(a first number) – (a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26 -100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7 – 91.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Further, it should be noted that terms of approximation (e.g., “about”, “substantially”, “approximately”, etc.) are to be interpreted according to their ordinary and customary meanings as used in the associated art unless indicated otherwise herein. Absent a specific definition within this disclosure, and absent ordinary and customary usage in the associated art, such terms should be interpreted to be plus or minus 10% of the base value.

The term “selective” or “selectively,” unless otherwise indicated, is taken to mean that the operation or function is capable of being performed by the structure or device in reference, but the operation or function may not occur continuously or without interruption. Furthermore, a selective or selectively performed operation may be one that the user or operator of a device or method may choose whether or when to perform, but the function or operation is nevertheless fully operative on or within the relevant device, machine, or method and the same includes the necessary structure or components to perform such operation

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. A system for filtering hydraulic fluid operating in a motion compensation system comprising:
an inlet filter hydraulically connected to the motion compensation system via a first flow control valve to receive a portion of hydraulic fluid passed under pressure from the motion compensation system to the accumulator; and
an outlet filter hydraulically connected to the motion compensation system via a second flow control valve;
wherein the outlet filter is hydraulically connected to the inlet filter to return at least a portion of the hydraulic fluid received at the inlet filter back to the motion compensation system when the motion compensation system reduces an internal pressure.

2. The system of claim 1, wherein the first and second flow control valves comprise first and second check valves, respectively.

3. The system of claim 1, further comprising a filter accumulator hydraulically connected to the inlet filter and outlet filter.

4. The system of claim 1, further comprising a first isolation valve interposing the inlet filter and the motion compensation system.

5. The system of claim 4, further comprising a second isolation valve interposing the outlet filter and the motion compensation system.

6. The system of claim 5, wherein the first flow control valve interposes the first isolation valve and the inlet filter.

7. The system of claim 5, wherein the second flow control valve interposes the second isolation valve and the outlet filter.

8. The system of claim 5, further comprising a manifold containing the first and second one way valves and the first and second isolation valves.

9. The system of claim 5, wherein the manifold is affixed to a first external canister containing the inlet filter and a second external canister containing the outlet filter.

10. The system of claim 9, wherein the manifold provides an external connection to the inlet filter via the first isolation valve and the first flow control valve, and provides a second external connection to the outlet filter via the second isolation valve and the second flow control valve.

11. A system for filtering hydraulic fluid that is periodically pressurized by a motion compensation system attached to an external load, the system for filtering hydraulic fluid comprising:
a first filter;
a first flow control valve that passes fluid from the motion compensation system under a first higher pressure to the first filter; and
a second flow control valve that passes fluid back to the motion compensation system when the motion compensation system produces a second lower pressure.

12. The system of claim 11, further comprising a second filter that filters fluid as it is passed back to the motion compensation system.

13. The system of claim 12, further comprising a first isolation valve that selectively stops the flow of hydraulic fluid from entering the first filter.

14. The system of claim 13, further comprising a second isolation valve that selectively stops the flow of fluid from leaving the second filter from flowing back to the motion compensation system.

15. The system of claim 14, further comprising a filter accumulator that receives filtered fluid from the first filter before it is passed back to the motion compensation system.

16. The system of claim 15, further comprising a third isolation valve that selectively interrupts hydraulic fluid flow to and from the filter accumulator.

17. The system of claim 16, further comprising a manifold containing the first and second one way valves and the first, second, and third isolation valves and providing interconnections between the first and second filters, the filter accumulator, and the motion compensation system.

18. A method for filtering hydraulic fluid circulating from a motion compensation system at periodic first higher pressures and second lower pressures comprising:
receiving the hydraulic fluid from the motion compensation system at the first higher pressure through a first flow control valve and a first filter; and
returning the hydraulic fluid to the motion compensation system at the second lower pressure through a second flow control valve.

19. The method of claim 18, further comprising passing the hydraulic fluid through a second filter before it enters the second flow control valve.

20. The method of claim 19, further comprising receiving hydraulic fluid from the first filter into a filter accumulator before it is passed through the second filter.
